(19) United States
(12) Patent Application Publication
(10) Pub. No.: US 2003/0167314 A1
(43) Pub. Date: Sep. 4, 2003

(54) Secure communications method

(76) Inventors: Martyn Gilbert, Cambridge (GB); Helen Ashman, Nottingham (GB)

Correspondence Address: BROOKS & KUSHMAN, 1000 TOWN CENTER 22ND FL, SOUTHFIELD, MI, 48075

(21) Appl. No.: 10/312,135

(22) PCT Filed: Jun. 19, 2001
(86) PCT No.: PCT/GB01/02704

(30) Foreign Application Priority Data
Jun. 19, 2000 (GB) 0014980.7
Sep. 28, 2000 (GB) 0023813.9
Nov. 7, 2000 (GB) 0028109.7

(51) Int. Cl. G06F 15/16

(52) U.S. Cl. 709/217

(57) ABSTRACT

A secure communications method comprises the steps of: fragmenting a digital message into a series of fragments, at least some of the fragments being smaller or larger than the smallest base unit of data used by the communications network: carrying out a reversible operation on the fragment stream, sending the fragment stream through at least one digital communication network; and reversing the operation carried out on the fragment stream to reproduce the digital message. The use of some fragments smaller or larger than the smallest base unit of data used by the network ensures that some of the fragments are non-symbolic. That is, the fragments do not correspond to symbols, symbols being the smallest unit of data used by communications network. Thus, frequency analysis attacks are thwarted.

This invention relates to a secure communications method and particularly to a secure communications method for communication across a digital communications network.

Where a message is transmitted electronically across a digital communications network it is well known that there is a potential danger that the message may be intercepted by unauthorised third parties.

Traditionally, this problem has been addressed by the message originator encrypting the message before sending it. The authorised recipient of the message knows how to decrypt the message, so the message is still readily accessible to the intended recipient. However, unauthorised third parties do not know how to decrypt the message and so cannot gain access to the message even if they successfully intercept the encrypted message.

In practice however it is possible that the unauthorised third party may be able to decrypt the encrypted message and so gain unauthorised access to the message contents.

It is generally accepted that any encryption technique can be defeated if sufficient resources and time are spent on breaking the encryption to allow the original message to be read. As a result, the usual standard used in assessing the security of encrypted messages is to encrypt the message using an encryption technique which will take an unauthorised eavesdropper so much cost or time to decrypt that the original message will either not be of sufficient interest or value to justify the cost or will no longer be of interest or value by the time it is accessible.

Accordingly, the security of all messages sent over communications networks must be regarded as questionable, particularly because estimates of the time taken to break encryption must always be based on assumptions as to the resources and techniques available to the would be unauthorised third party attempting decryption.

This invention is intended to provide a secure communications method overcoming these problems, at least in part.

This invention provides a secure communications method comprising the steps of:

fragmenting a digital message into a series of fragments, at least some of the fragments being smaller or larger than the smallest base unit of data used by the communications network;

carrying out a reversible operation on the fragment stream,

sending the fragment stream through at least one digital communication network; and

reversing the operation carried out on the fragment stream to reproduce the digital message.

The use of some fragments smaller or larger than the smallest base unit of data used by the communications network ensures that some of the fragments are non-symbolic. That is, the fragments do not correspond to symbols, symbols being the smallest base unit of data used by the communications network.

Advantageously, the use of encryption algorithms specifically designed for use with non-symbolic fragmentation makes it possible to employ stream ciphers to encrypt individual fragments before assignment to partial messages. While frequency analysis has been successfully employed against stream ciphers in the past, the use of non-symbolic fragmentation means that no whole symbol can be identified from the fragments. Whole symbols are probably, but not necessarily, present in any fragment whose size is greater than the smallest base unit of data used by the communications network or any participating applications or symbol, however a cryptanalyst will encounter difficulty in detecting at what point in the fragment the whole symbol occurs, if it does at all.

Additionally, the size of fragments can be varied according to a method that is a secret shared between the sender and receiver. This means that a cryptanalyst ought not to know even where the boundaries of any individual fragment occur, and hence cannot apply frequency analysis at all. Varying fragment sizes also means that known-plaintext attacks are made greatly more difficult while brute-force attacks are greatly increased in complexity.

Advantageously, security can be further enhanced by encrypting the partial messages composed of the fragment streams, which may or may not have previously made use of stream ciphering as described in the previous paragraph, using a stream or block cipher algorithm specifically designed for use with non-symbolic fragmentation.

In general, any attack on an encryption algorithm whose basis for attack relies on detecting characteristics in the data will be greatly weakened by making use of encryption algorithms specifically designed for use with non-symbolic fragmentation, in particular when the fragment sizes are varied according to a method that is a secret shared between the sender and receiver.

Advantageously, the reversible operation includes dividing the fragments into a plurality of fragment streams;

forming a plurality of partial messages, each incorporating a fragment stream; and

recombining the fragment streams from the partial message.

This provides the advantage that a third party intercepting one of the partial messages cannot reproduce the overall message.

Advantageously, in order to make it more difficult for a third party to intercept all of the partial messages or to identify intercepted partial messages as relating to the same original message the partial messages may be sent to or from two or more network addresses.

Advantageously, some of the plurality of partial messages may be sent through different ones of two or more service providers and most preferably at least some of the plurality of partial messages may be sent through different ones of at least two separate networks.

Preferably, at least one of the partial messages is sent through an intermediate node.

Preferred embodiments of the invention will now be described by way of example only with reference to the accompanying diagrammatic figures, in which:

FIG. 1 shows a first embodiment of the invention;

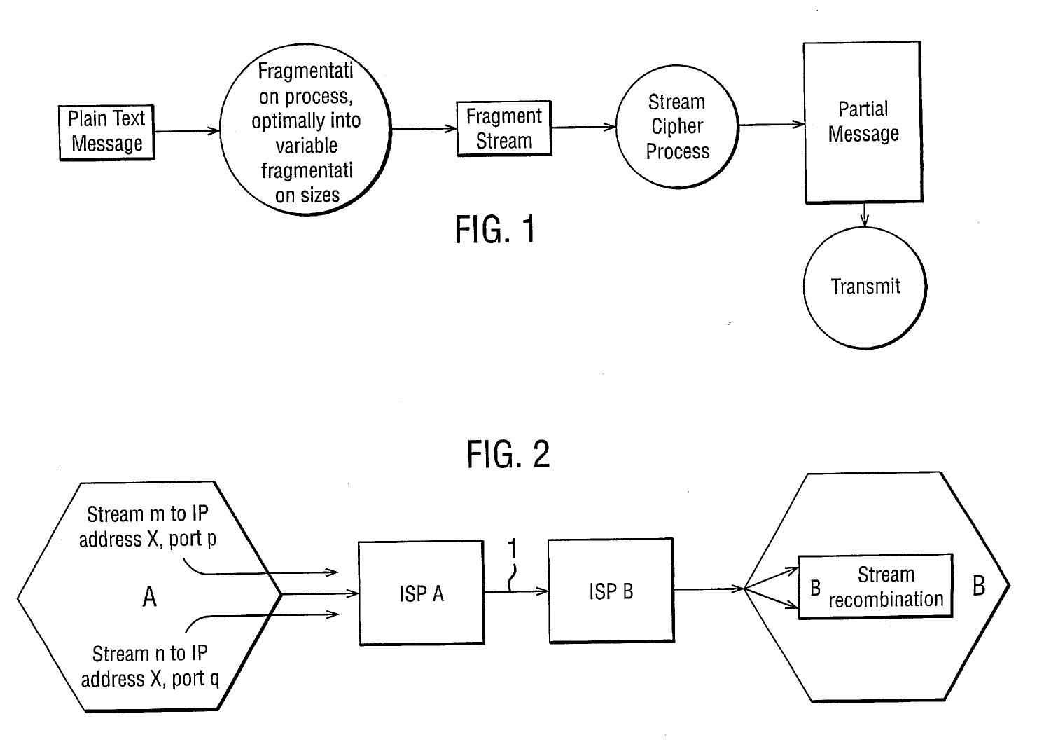

FIG. 2 shows a second embodiment of the invention;

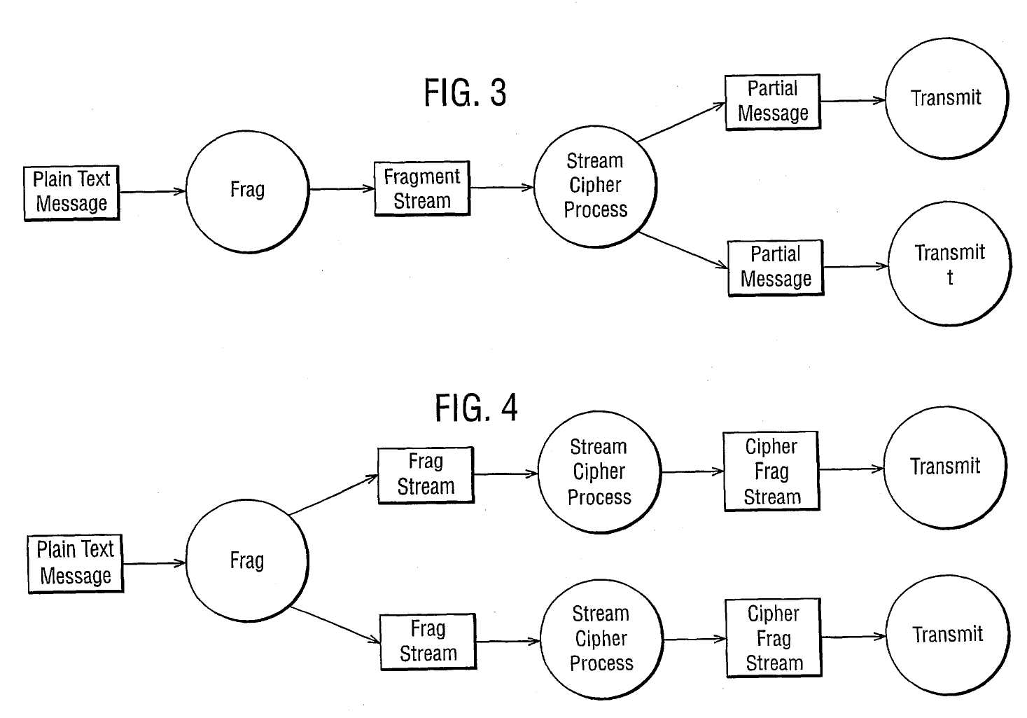

FIG. 3 is an explanatory diagram showing use of an encryption technique in the second embodiment of the invention;

FIG. 4 is a further explanatory diagram showing an encryption technique used in the second embodiment of the invention;

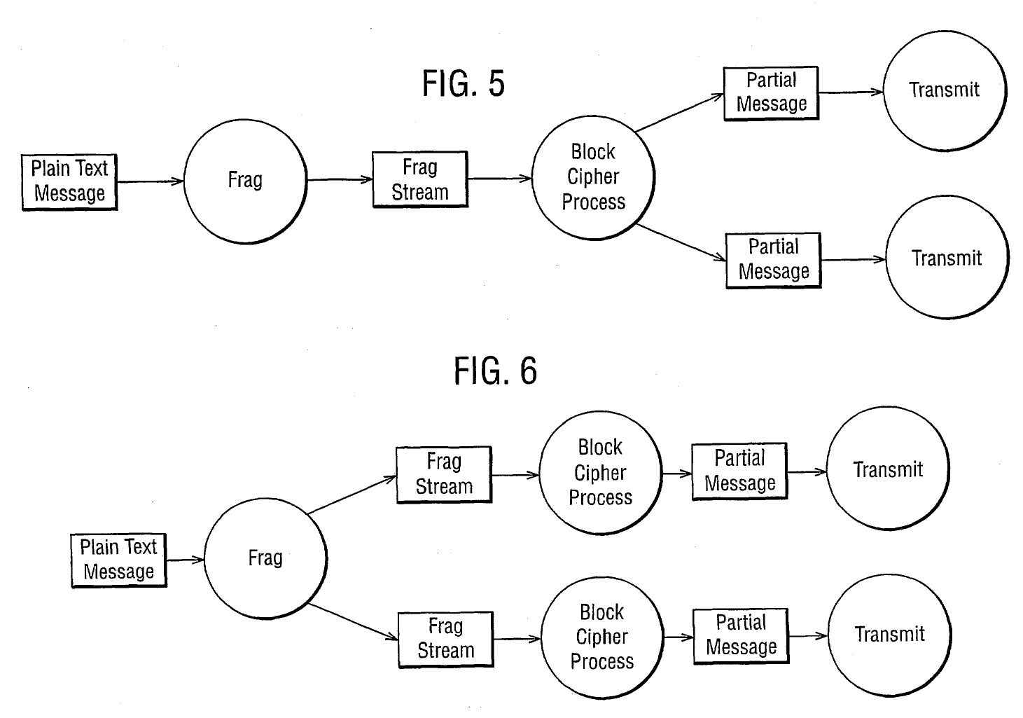

FIG. 5 is a further explanatory diagram showing an encryption technique used in the second embodiment of the invention;

FIG. 6 is a further explanatory diagram showing an encryption technique used in the second embodiment of the invention;

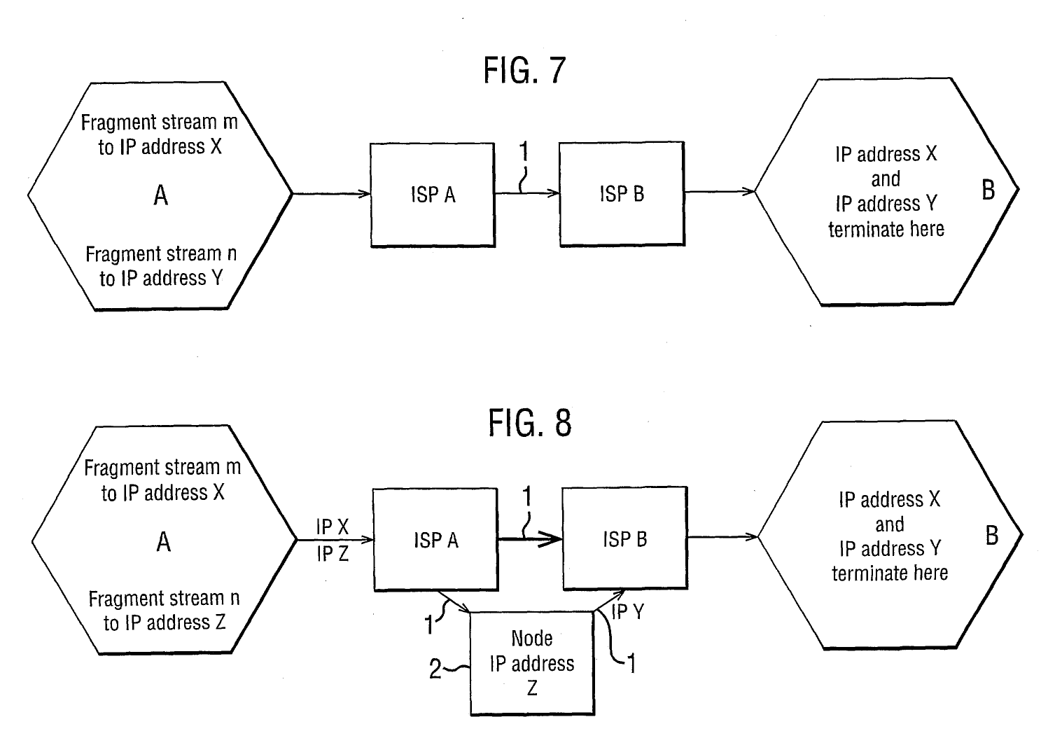

FIG. 7 shows a third embodiment of the invention;

FIG. 8 shows a fourth embodiment of the invention;

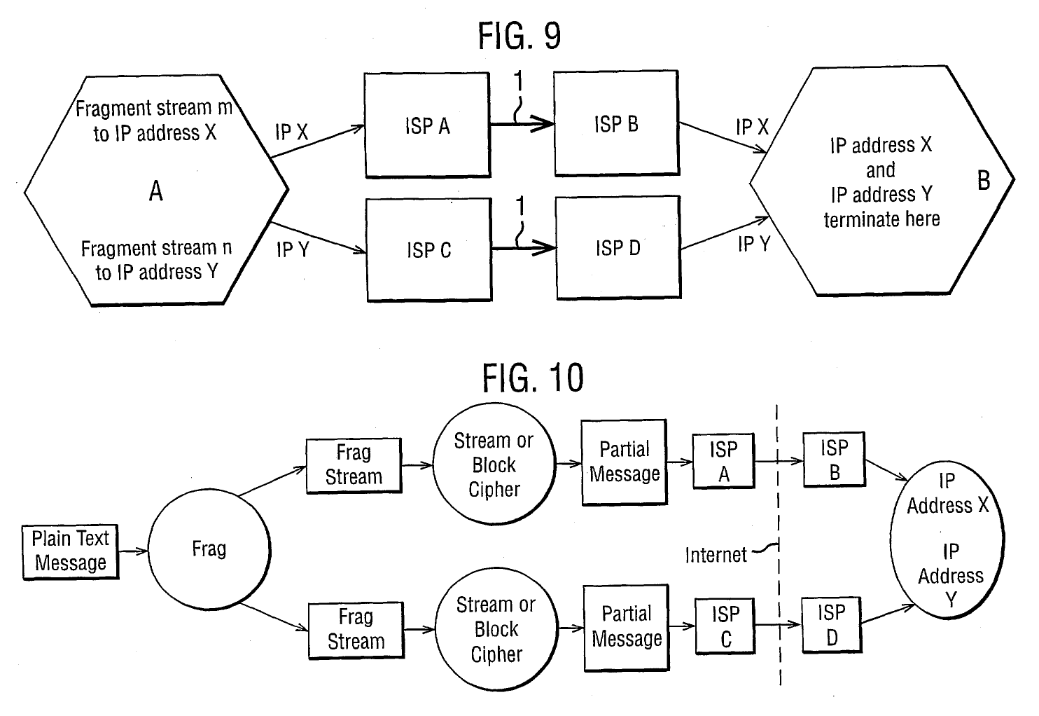

FIG. 9 shows a fifth embodiment of the invention;

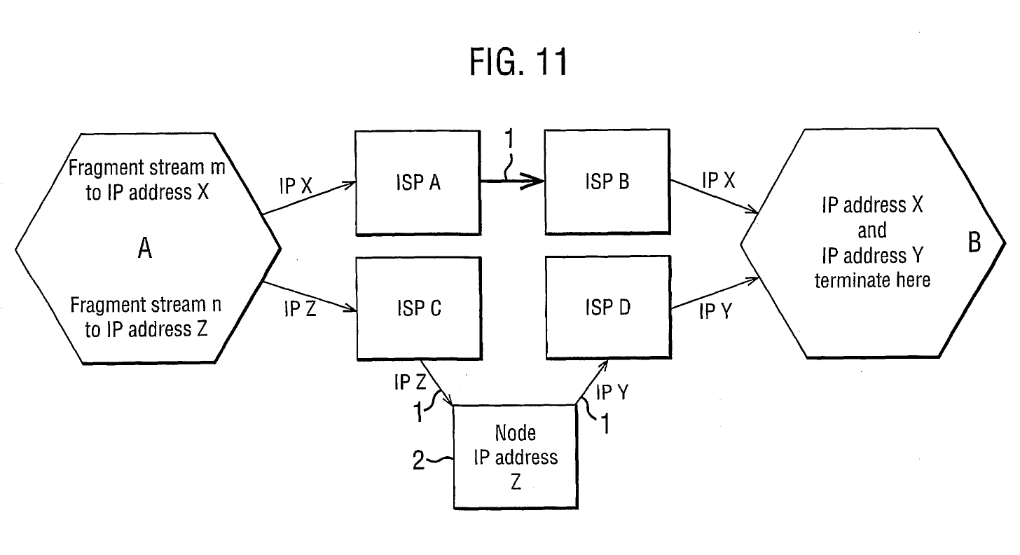

FIG. 10 is an explanatory diagram showing an encryption technique used in the fifth embodiment;

FIG. 11 shows an example of the invention combining the third and fourth embodiments;

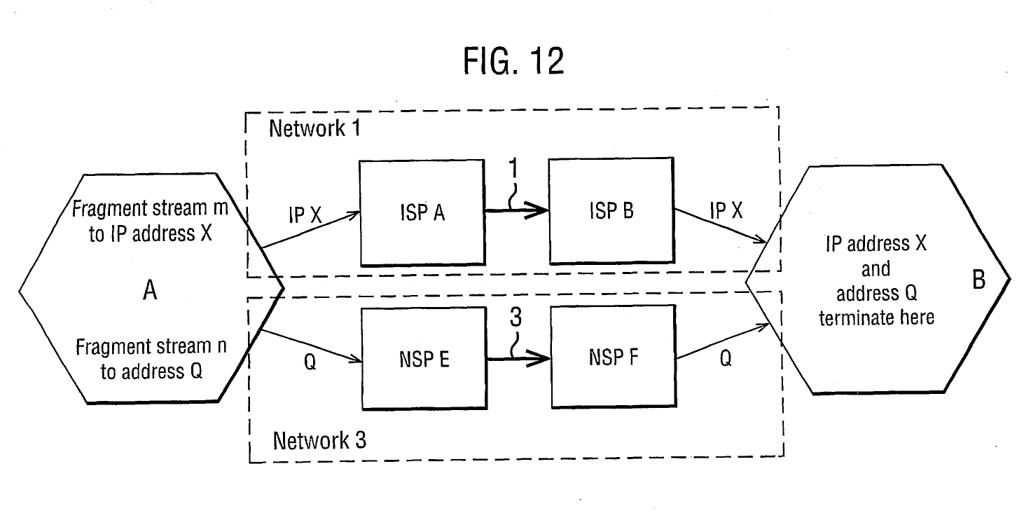

FIG. 12 shows a sixth embodiment of the invention;

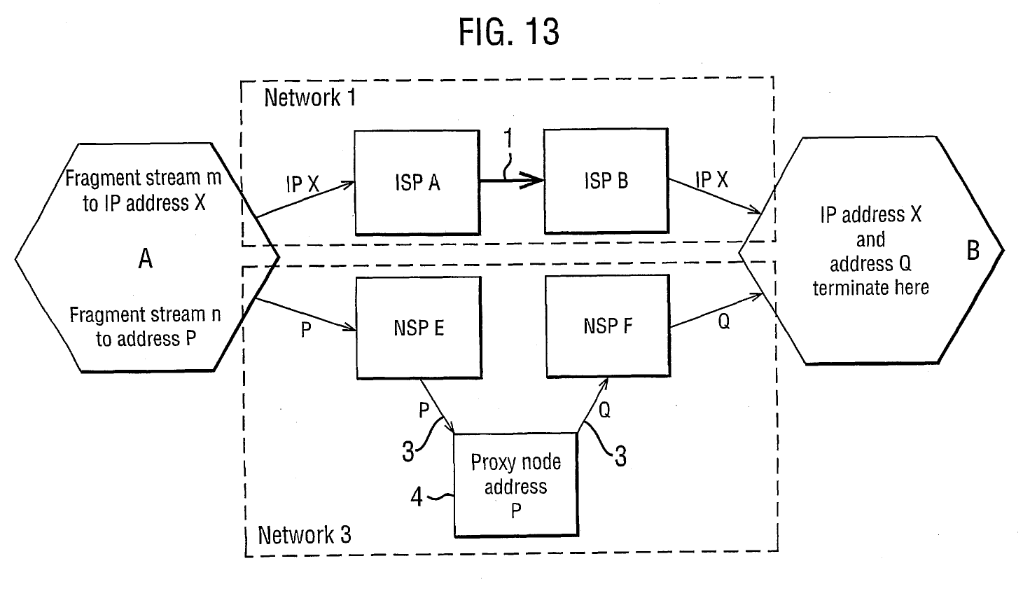

FIG. 13 shows an example of the invention combining the fourth and sixth embodiments; and

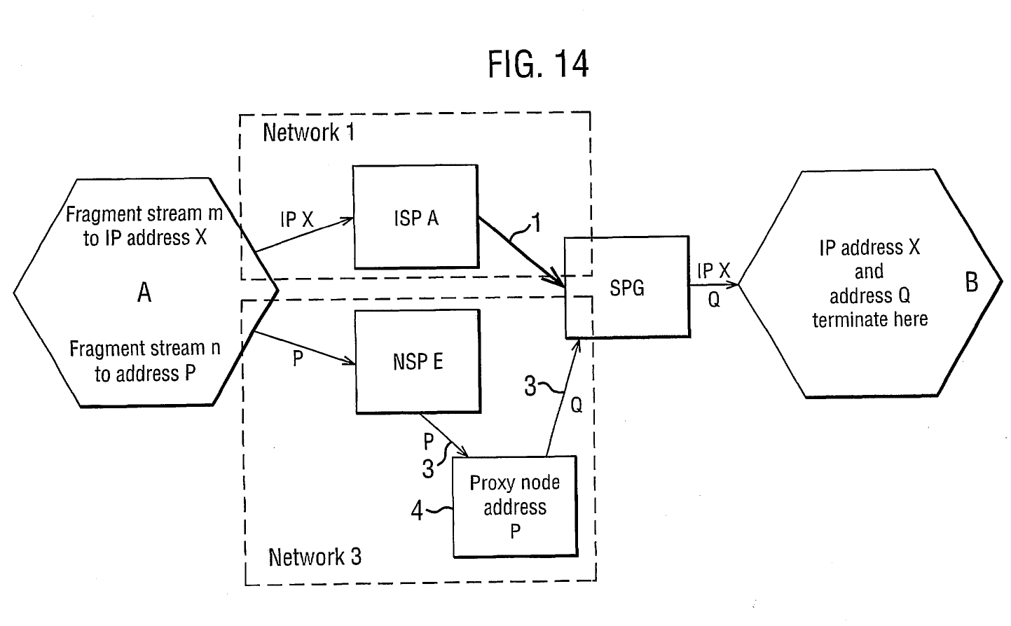

FIG. 14 shows a further example of the invention combining the fourth and sixth embodiments.

The core of this invention is the breaking up of the original message into fragments where the fragment boundaries usually do not exactly coincide with symbol boundaries. Previous work in cryptographic algorithms relied on encrypting one whole symbol at a time, and such algorithms are called stream ciphers, or else on encrypting “blocks” (contiguous sets of whole symbols) of data, with such algorithms being called block ciphers. Stream ciphers are now very rarely used due to the success of cryptanalytical attacks such as frequency analysis which can be employed against stream ciphers. By counting the relative frequencies of symbols in general use (for example, the letter “e” occurs about 12% of the time in normal English prose), it is possible to make educated guesses to discover which digit in the ciphered text is the encrypted version of a given letter in the plain text. Block ciphers were invented in response to the success of frequency analysis against stream ciphers, and now are the basis of the great majority of ciphers, both secret-key and public-key, in use today.

The use of non-symbolic fragmentation of messages prior to encryption and formation of data streams for further optional encryption and transmission is a radical departure from the prior art in encryption algorithms. In the first instance, it again becomes possible to use stream ciphers on data to provide a high level of security because the base unit of encryption is no longer a fixed size whole symbol, for example letters of the alphabet, but can now be unpredictably-sized fragments composed of strings of binary digits. Frequency analysis relies on a comprehension of the relative frequencies of whole letters in use in an alphabet, and this relies on three axiomatic conditions, these being firstly that each whole symbol is encrypted, resulting in another whole symbol, secondly, the knowledge of where each symbol begins and ends in the message and thirdly the consistency of size of the unit of encryption in the message. The non-symbolic fragmentation of a message removes the assumption that whole symbols are encrypted to other whole symbols, while the additional use of a secret method to determine the sizes of fragments removes the knowledge of where each symbol begins and ends in both plain text and ciphered text, and for a stream cipher it also removes the consistency of size of the unit of encryption.

In order for non-symbolic fragmentation as explained above to be effective it is necessary that at least some of the fragments be smaller or larger than the base unit of data used by the communications network. Where the original message is made up of symbols this base unit of data will usually correspond to a single symbol. For example, where a document or text message is being sent the symbols will be alphanumeric symbols. In other situations where the original message is not made of symbols, for example where the message is a digitised image or audio or video signal the concept of symbols may not be meaningful and accordingly the term base unit of data has been employed herein.

Considering the situation where the original message is alphanumeric characters and the base unit of data corresponds to the symbol is useful to allow the invention to be readily understood and it is expected to be one of the most common applications of the invention. Accordingly, the invention is discussed herein with reference to symbols. However, it is believe that all of the techniques described herein are applicable to applications in which the communications network employs a base unit of data but the original message is not made up of characters or symbols.

It should be noted that it is only essential that at least some of the fragments be shorter or longer than the smallest multi-bit data unit used. Where a fixed fragment length is used this fragment length must be smaller than the base unit of data or larger than the base unit of data but not an integer multiple of the base unit of data length. However, where variable fragment lengths are used there is no reason why some of the fragments should not be equal in length to the smallest data unit used. In fact, there is no absolute reason why fragments equal to or larger than several integer multiple times the smallest data unit used should not be possible fragment lengths in a variable length method. However, such long fragments are generally undesirable because they allow for the possibility of the content of an individual fragment being meaningful in isolation. However, this possible weakening of the cryptographic protection provided will be to some extent balanced by the fact that the greater the possible range of fragments which could be used the more complex it is to decrypt the non-symbolically fragmented message.

The ciphering process may or may not require a secret key. For example a very simple yet reasonably secure method would be to simply reverse the order of the fragments, thus not requiring a secret key at all. This reversal would not be a particularly effective cipher on its own because it could be attacked by heuristic data comprehension techniques or, if the algorithm is known, by reversing the fragments again, using it in conjunction with the variable fragment sizing which is governed by a secret shared by a sender and recipient makes this a reasonably strong transposition cipher.

A more secure method would be to transpose the fragment order according to an algorithm or sequence known only to the sender and receiver. This would be particularly effective when combined with variable fragment sizing.

A first embodiment of the invention is shown in FIG. 1. This illustrates how stream ciphers can make use of fragmented message immediately before or after the creation of single fragment stream.

In FIG. 1 a message originator A wishes to send a message to a message recipient B. FIG. 1 shows the process carried out by the message originator A before sending the message. This will be reversed by the recipient B to reproduce the original message.

The message is in the form of digital information and is divided up by A into a series of small fragments, each of which is smaller than the base unit of data or symbol normally used for communications. For example, computers typically use 8, 16 or 32 bit (binary digit) data units, to represent, store and transmit information. The most common base unit of data for text sent across an electronic communications network is ASCII format in which the individual symbols are 8 bits in length and correspond to individual alphanumeric characters.

The fragments may be in portions as small as one bit and can be as large as required for reasonably secure encryption purposes. To avoid possible cryptanalytical attack by heuristic comprehension of data which may occur with larger sized fragments, where a symbol is the standard 8 bit data unit an upper bound of fragment size of 15 bits per fragment is preferred as many fragments of this size will not contain a whole symbol.

The message to be sent, known as the plaintext message, is broken into non-symbolic fragments, thus creating a single fragment stream.

It is possible for the fragment size to be fixed. However, security is increased if the fragment size is varied according to a method that is a secret shared between the sender and receiver. Uniformly-sized fragments are less secure than variable-sized fragments, as it is possible for frequency analysis to be applied to the bit level, although the computational complexity may render the effort not worthwhile for an eavesdropper, especially for larger-sized fragments. This is the same principle as that which motivated block ciphers, except that uniformly-sized fragments are dealing with bits instead of symbols.

The single fragment stream is then passed through a stream ciphering process, with each fragment being enciphered individually. The enciphered fragments are then combined to create a single partial message which is then ready for transmission.

Note that, as described below for the second embodiment of the invention, employing a stream cipher after the creation of a fragment stream is logically equivalent to employing a stream cipher immediately before the creation of a fragment stream. In each case, the fragments are individually ciphered.

Thus, this invention provides a new method by which the security of messages sent over communication networks can be improved.

However, it is still the case that in theory a message encrypted by non-symbolic fragmentation according to this invention could still be decrypted if sufficient time and resources were available. Further, even use of this invention will not prevent a third party having unauthorised access to the information required to decrypt the encrypted message, such as the encryption keys used for the stream ciphering and the fragment length or sequence of changes in fragment length used, from decrypting an intercepted message to derive the original message as quickly and easily as the intended recipient.

A further aspect of the invention is intended to overcome these further problems.

This aspect of the invention is based on a realisation that the underlying reason why any encrypted message can be decrypted is that all of the information making up the original message is contained within the encrypted message. Accordingly, it is always theoretically possible for this information to be extracted from the encrypted message and the original message reproduced.

The basic concept of this further aspect of the invention is that a fragmented message according to the invention to be sent from a message originator to a message recipient should be divided into multiple parts. These parts are then used to form multiple separate partial messages each containing only a part of original message information which are sent from the message originator to the message recipient.

The message recipient can recombine the information content of the multiple received partial messages to reproduce the original message. However, an unauthorised third party eavesdropper intercepting only some of the partial messages cannot reproduce the original message regardless of the resources or time spent in the attempt because the intercepted partial message or messages do not include all of the information content of the original message or allow the whole information content to be deduced, so that the information content of the original message cannot be extracted from the partial message. Further, because the fragments into which the original message is divided are non-symbolic and small relative to the size of the original message it will not even be possible to reproduce a part of the original message because without the missing fragments of the original message the relationships between the parts of the original message contained in the intercepted partial message or messages cannot be determined or deduced.

In this application the term message is used. The term message is used only to refer to a quantity of digital information to be sent from an originator to a receiver. There is no requirement that the message be all of the information to be sent. A single communication session may involve the transfer of many messages. This digital information may represent numerical data or text but could also be image data or audio or video data.

The information making up the message may be encrypted by some known encryption technique before or after being broken into multiple parts or both. Such encryption can be added to the method of the present invention to increase the level of security provided but the use of such further encryption is optional and not essential.

In general, the greater the number of parts the original message is divided into and the greater the corresponding number of partial messages sent, the greater the degree of security provided. Further, the greater the degree of diversity in the routes by which the partial messages are sent from the originator to the receiver the greater the degree of security which will be provided as will be explained below.

An example of use of a second embodiment of the invention will now be described with reference to FIG. 2.

In FIG. 2 a message originator A wishes to send a message to a message recipient B.

The message is in the form of digital information and is divided up by A into a series of small fragments, each of which is smaller than the base unit of data normally used for communications. For example, computers typically use 8, 16 or 32 bit (binary digit) data units, to represent, store and transmit information.

The fragments may be in portions as small as one bit but more typically would be in the range 2 to 7 bits so that they were smaller than the smallest standard 8 bit data unit used. The series of fragments is then divided into two partial messages M and N each of which comprises a fragment stream m or fragment stream n.

The simplest approach is to divide the stream of fragments into partial messages by assigning fragments alternately or cyclically to partial messages, but more complex assignment methods may be used in order to male combination of partial messages to obtain the original message more difficult. Further, the order of the fragments in the partial messages may be altered.

In this example the message originator A and the message recipient B are able to communicate over the Internet 1 through respective first and second Internet service providers ISP A and ISP B.

The message originator A sends the partial messages M and N to the IP address X of the message recipient B by sending the two partial messages M and N to the first ISP A. The first ISP A then forwards the two partial messages M and N to the second ISP B through the Internet 1 and the second ISP B then sends the two partial messages M and N to message recipient B.

The message recipient B then recombines the fragment streams contained in the two partial messages M and N to reform the original message.

This method of the second embodiment is referred to as stream diversity because the partial messages are formed by separated streams of message fragments.

The partial messages M and N form separate logical groups of message fragments with no intrinsic coherence or other relationship between them except that they are destined for the same recipient. Only the message originator A and the message recipient B know the necessary relationship between the partial messages or the fragment streams which will allow the original message to be correctly reconstructed from the partial messages.

In the second embodiment the original message is only divided into two fragment streams and two corresponding partial messages. Any number of fragment streams and partial messages could be used, although in practice it is expected that the number of partial messages will normally be in the range 2 to 16.

In this embodiment, if an unauthorised third party intercepts one of the two partial messages they will not be able to reassemble the original message or any coherent part of the original message.

Further, even if a third party manages to intercept both of the partial messages they will not know how the information fragments contained in the two partial messages should be recombined to reproduce the original message.

Where the fragments are divided into more than two streams so that more than two partial messages are produced and sent, a third party will not be able to reassemble the original message even if several of the partial messages are intercepted, provided that not all of the partial messages are intercepted.

Although stream diversity as used in the second embodiment where the multiple partial messages are sent from the message originator A to the message recipient B through a single Internet route provides a level of security, this arrangement is vulnerable to a third party intercepting all of the partial messages because they are all transmitted along a single Internet route and so may pass along a single physical communications link. Although, as explained above, the third party will not know how to recombine the message fragments to reproduce the original message, a third party having all of the partial messages will have all of the information making up the original message, which is contained in the partial messages. Accordingly, similarly to a conventional encrypted message, it is theoretically possible for the original message to be reproduced from the partial messages.

The use of changing fragment length can be used in the method of the second embodiment where stream diversity is used in order to increase the level of security of the transmitted message in case a third party intercepts all of the partial messages. As explained above regarding the first embodiment of the basic non-symbolic fragmentation invention, the use of varying fragment lengths where the changes in fragment lengths are known only to the message originator A and the message recipient B will provide improved security against decryption. However, even if fixed fragment lengths are used a third party will not be able to derive the original message from one or more intercepted partial messages unless all of the partial message are intercepted.

As explained above, the use of stream diversity according to the second embodiment of the invention will provide completely secure communications if not all of the partial messages are intercepted by the third party and will provide a high degree of security even if all of the messages are intercepted. As noted above, it is possible to provide further security by encrypting the transmitted partial messages formed by the fragment streams.

The use of stream ciphers in the second embodiment of the invention will now be described with reference to FIG. 3.

In the second embodiment a message originator A wishes to send a message to a message recipient B. Again, only the process carried out by the message originator A is shown.

The message to be sent is broken into non-symbolic fragments, thus creating a single fragment stream. As with the first embodiment of the invention, it is preferred that fragment sizes can be varied according to a method that is a secret shared between the sender and receiver and that the upper bound of fragment sizes can be chosen accordingly.

The single fragment stream is then passed through a stream ciphering process, with each fragment being enciphered individually. The enciphered fragments are then assigned to a number of distinct partial messages each of which are then ready for transmission.

For improved security, it is recommended that the assignment of each fragment to its partial message be done according to a method that it a secret shared between the sender and receiver. If varying fragment sizes are also used, this method may or may not be the same as the method use to determine fragment sizes. The reason for this is that an eavesdropper who successfully intercepts one or all of the partial messages will not know which fragments occur in any given messages. However, it is also possible to assign fragments to separate partial messages on a cyclic or other simple and non-secret basis.

An alternative arrangement is shown in FIG. 4.

In this arrangement of the second embodiment a message to be sent by the message originator A is broken into non-symbolic fragments to create a single fragment stream.

The single fragment stream is then assigned to a number of distinct partial messages. As explained above regarding the second embodiment of the invention the number of separate fragment streams and corresponding partial messages may be varied as required but for simplicity only two fragment streams for incorporation into two partial messages are illustrated.

Each of the separate fragment streams is then separately passed to a stream ciphering process so that each fragment is enciphered individually. The enciphered fragment streams making up the partial messages are then ready for transmission.

It should be noted that employing a stream cipher after separation of the fragments into separate fragment streams is logically equivalent to employing the stream cipher on the initial fragment stream before its separation into separate fragment streams. In each case, the fragments are individually enciphered by the stream cipher process.

A further process for use in the second embodiment using block ciphers to encipher the parts of the messages according to the second embodiment is shown in FIG. 5. This shows the encryption and fragmentation process carried out by the message originator A.

The message to be sent is broken into non-symbolic fragments, thus creating a single fragment stream. As with the first embodiment of the invention, it is recommended that fragment sizes be varied according to a method that is a secret shared between the sender and receiver and that the upper bound of fragment sizes be chosen accordingly.

The single fragment stream is now passed through a block cipher. The fragment stream must be disordered in some way before being block enciphered so that fragments which are contiguous in the plain text are not contiguous in the fragment stream. The reason for this is that if the order of fragments is not changed, then the fragmentation is rendered without effect by the block cipher which deals with fixed size sets or blocks of bits.

Having block ciphered the fragment stream, the ciphered blocks can be assigned to one or more partial messages which are then ready for transmission.

Block ciphering techniques divide messages up into blocks having a fixed bit length. Accordingly, where the fragment stream is disordered and then passed through a block cipher before being separated into separate partial messages the partial messages may no longer correspond to individual fragments. That is, it is generally more convenient to divide the enciphered blocks of fixed sized output from the block cipher into separate partial messages. If this is done, because the block cipher takes fixed length blocks of data from the fragmented and disordered fragment stream it will not necessarily be the case that each block enciphered block corresponds to a number of whole fragments. Instead, it is likely that at least some fragments will be split between two successive block cipher blocks. It might appear that in this situation the partial messages produced by dividing the enciphered blocks do not correspond to fragment streams because of the splitting of fragments between blocks. However, the splitting of the fragments between the blocks is merely a further stage of fragmentation so that even in this circumstance the partial messages correspond to separate fragment streams.

It would of course be possible to control the length of the fragments so that each block of the block cipher contained a number of whole fragments. However, this is regarded as being disadvantageous because such a limitation would weaken the cryptographic strength of the invention and is not expected to provide any compensating benefit.

A further example of the first or second embodiments of the invention is shown in FIG. 6.

In the second embodiment a message originator A wishes to send a message to a message recipient B.

The message to be sent is broken into non-symbolic fragments, thus creating a number of distinct fragment streams. As with the first embodiment of the invention, it is preferred that fragment sizes be varied according to a method that is secret shared between the sender and receiver and that the upper bound of fragment sizes to be chosen accordingly. As with the second embodiment of the invention it is preferred that the assignment of fragments to distinct fragment streams be done according to another method that is a secret shared between the sender and receiver.

Each distinct fragment stream is now passed through a block cipher and the ciphered blocks from any given fragment stream become part of a partial message. Each partial message is then ready for transmission.

In order to provide an increased level of security path diversity, in which the partial messages are sent along different communications links or routes can be used instead of the stream diversity of the second embodiment.

A third embodiment of the invention employing path diversity is shown in FIG. 7.

In the third embodiment a message originator A wishes to send a message to a message recipient B and the message originator A and the message recipient B are able to communication over the Internet 1 through respective first and second Internet service providers ISP A and ISP B similarly to the first embodiment.

In the third embodiment the message originator A divides the original message into two fragment streams m and n as before. The fragment stream m is then sent as a first partial message M to an IP address X while the second fragment stream n is sent as a second partial message N to a second IP address Y. The two partial messages M and N are sent by the message originator A to the first ISP A. The first ISP A then sends the two partial messages through the Internet 1 to the second ISP B. The second ISP B then sends the first and second partial messages M and N to their respective destination IP addresses X and Y, both of which terminate at the message recipient B.

The message recipient B then recombines the two partial messages to reproduce the original message.

In the third embodiment the partial messages travel on a single Internet route and as a result, similarly to the first embodiment, they will commonly all be conveyed over the same network and path and the same physical communications link. However, in communication networks in which IP addresses are dynamically assigned during a single Internet access session this method will provide greater security because of the increased difficulty a third party will have in identifying the partial messages being sent to the two IP addresses X and Y as being partial messages carrying parts of the same original message and both being sent to the same message recipient B. Where IP addresses are static the technique of the second embodiment will provide little or no security advantage over the second embodiment.

In the described embodiment two partial messages are sent to the two corresponding IP addresses at the recipient B. Where the original message is split into more than two partial messages and these are sent to multiple IP addresses at the message recipient B the number of IP addresses may be less than the number of partial messages so that more than one partial message is sent to some or all of the multiple IP addresses.

In order to provide a greater degree of security and full path diversity indirect addressing of one of the partial messages can be used. That is, one of the partial messages can be sent directly from the message originator to the message recipient while another partial message is sent from the message originator to a remote node and then resent from the remote node to the message recipient.

A fourth embodiment of the invention employing indirect addressing to provide path diversity is shown in FIG. 8.

Similarly to the third embodiment a message to be sent from a message originator A to a message recipient B through respective first and second Internet service providers ISP A and ISP B and the Internet 1, and the message recipient has two IP addresses X and Y.

As in the earlier embodiments the message originator A divides the original message into fragments to form it into two partial messages M and N. The message originator A addresses the first partial message M to go to the IP address X of the message recipient B while the second partial message N is addressed to go to an IP address Z associated with a node 2.

The node 2 is connected to the first and second ISP A and ISP B through the Internet 1 and it able to receive and resend messages.

The message originator A forwards the two partial messages M and N to the first ISP A and the first ISP A then sends the first partial message M through the Internet 1 to the second ISP B and sends the second partial message N through the Internet 1 to the address Z of the node 2.

The node 2 receives the second partial message N at its IP address Z and then resends the second partial message N to the IP address Y of the message recipient B by sending the second partial messages N through the Internet 1 to the second ISP B.

The second ISP B sends the first and second partial messages M and N to the IP addresses X and Y of the message recipient B. It should be noted that the times at which the ISP B sends the first and second partial messages M and N to the message recipient B are incoherent and have no specified relationship.

The full path diversity of the fourth embodiment makes interception and correlation of the partial messages by an unauthorised third party more difficult because the path followed by the first partial message from the first ISP A directly to the second ISP B is different from the path followed by the second partial message N from the first ISP A to the node 2 and then to the second ISP B and this different route will normally involve the first and second partial messages M and N travelling along different physical communications links. This route and physical separation of the partial messages M and N can be ensured by the use of a node 2 which is physically remote from the first and second ISP A and ISP B. Further, the second partial message N spends part of its journey addressed as a message travelling from the message originator A to the node 2 and another part of its journey addressed as a message from the node 2 to the message recipient B. As it result, it will be difficult for a third party to identify a second partial message N as being related to the first partial message M which is addressed directly from the message originator A to the message recipient B.

In the fourth embodiment the two partial messages M and N are sent to two different IP addresses X and Y at the message recipient B. This arrangement is preferred in order to provide the security advantages described with reference to the third embodiment, particularly in communication networks in which IP addresses are dynamically assigned during a single access session. However, the two partial messages M and N could both be sent to the same IP address of the message recipient B, although this would reduce the degree of security provided.

It should be noted that because communication networks rely on the address information carried by a message to deliver the message to the correct recipient it is not possible to disguise the fact that the first partial message M is being sent to an IP address of the message recipient B. However, while the second partial message is travelling between the message originator A and the node 2 the network only requires that the IP address of the node 2 be identified and accordingly the ultimate destination at the message recipient B can be concealed. This could be carried out by not including the ultimate IP address of the message recipient B in the second partial message M at all but instead instructing the node 2 to always forward messages received at its IP address instead to the IP address Y of the message recipient B. Alternatively, the destination IP address at the message recipient B could be concealed by encryption or by the second partial message N, or at least the part of it identifying the final destination address at the message recipient B, itself being divided into two or more partial messages so that these partial messages must be recombined at the node 2 in order to allow the ultimate destination to be identified.

Further, multiple nodes 2 could be arranged in series so that a partial message passes from one node to another node. Also, the partial message routes could be selected so that all of the partial messages pass through at least one node 2. Use of multiple nodes in this way will allow the true recipient or originator of the original message to be completely concealed from eavesdroppers.

In order to provide a greater degree of security, path diversity can be increased further by the use of multiple network connections. That is, if both the message originator A and the message recipient B are connected to the Internet through two separate ISP's the partial messages can be sent through different pairs of ISP's so that route and physical separation of the partial messages is assured even when the message is being handled by the ISP's themselves.

A fifth embodiment of the invention employing multiple connection to provide path diversity is shown in FIG. 9. Similarly to the third embodiment, a message originator A is able to communicate with a message originator B through the Internet 1. In the fifth embodiment the message originator A has associated first and third Internet service providers ISP A and ISP C while second and fourth Internet service providers ISP B and ISP D are associated with the message recipient B.

As in the earlier embodiments the message originator A divides the original message into fragments to form it into two partial messages M and N. The message originator A addresses the first partial message M to go to the IP address X of the message recipient B while the second partial message N is addressed to go to a second IP address Y of the message recipient B.

The message originator A forwards the two partial messages M and N to the first ISP A and third ISP C respectively. The first ISP A then sends the first partial message M through the Internet 1 to the second ISP B while the third ISP C sends the second partial message N through the Internet 1 to the fourth ISP D.

The second ISP B sends the first partial message M to the IP address X of the message recipient B while the fourth ISP D sends the second partial message N to the IP address Y of the message recipient B.

The first and third ISP A and ISP C and the second and four ISP B and ISP D will normally be physically remote from one another so that the communication path through the Internet 1 followed by the two partial messages and the physical communications links they traverse will be entirely different, making interception and correlation of the first and second partial messages by third parties difficult.

In the present application correlation of the partial messages is used to mean the correct identification of partial messages as being partial messages derived from the same original message.

In the fifth embodiment the two partial messages M and N are sent to different IP addresses X and Y of the message recipient B. For the reasons explained above regarding the third embodiment this arrangement is preferred to increase security. However, the two partial messages M and N could both be sent to the same IP address of the message recipient B provided that this IP address was accessible to both the second and fourth ISP B and ISP D, although this would reduce the degree of security provided.

In the third to fifth embodiments a message originator A wishes to send a message to message recipient B.

The message to be sent is broken into non-symbolic fragments, thus creating a number of distinct fragment streams. As with the first embodiment of the invention, it is recommended that fragment sizes be varied according to a method that is a secret shared between the sender and receiver and that the upper bound of fragment sizes be chosen accordingly. As with the second embodiment of the invention it is recommended that the assignment of fragments to distinct fragment streams be done according to another method that is a secret shared between the sender and receiver.

Each distinct fragment stream is now passed through a block cipher and the ciphered blocks from any given fragment stream become part of a partial message. Each partial message is then ready for transmission. Partial messages are transmitted from distinct sending IP addresses and are destined for distinct recipient IP addresses.

The described embodiments can be combined to provide increased levels of security.

In order to provide a still greater degree of security, path diversity can be increased still further by combining of the fourth and fifth embodiments. That is, in addition to the use of multiple connection through multiple ISP's, the path of one of the partial messages through the ISP's could be extended to pass through a proxy node.

Such an arrangement combining the features of the fourth and fifth embodiments is shown in FIG. 11.

The arrangement of FIG. 11 is based on the arrangement of FIG. 9 and functions similarly except that a node 2 is provided connected to the third and fourth ISP C and ISP D.

Similarly to the fifth embodiment the message originator A divides the original message into fragments to form it into two partial messages M and N. The first partial message M is sent to the IP address X of the message recipient B by the message originator A forwarding it to the first ISP A. The first ISP A then sends the first partial message M through the Internet 1 to the second ISP B. The second ISP B then sends the first partial message M to the IP address X of the message recipient B.

The message originator A addresses the second partial message N to go to the IP address Z of the node 2 and forwards the second partial message N to the third ISP C. The third ISP C forwards the second partial message N through the Internet 1 to the IP address Z of the node 2.

The node 2 receives the second partial message N at its IP address Z and then resends the second partial message N to the IP address Y of the message recipient B by forwarding the second partial message N through the Internet 1 to the fourth ISP D. The fourth ISP D then sends the second partial message N to the IP address Y of the message recipient B.

The example of FIG. 11 combining the fourth and fifth embodiments of the invention provides increased security against interception by providing full path diversity and also ensuring that the second partial message N spends part of its journey addressed as a message travelling from the message originator A to the node 2 and then a part of its journey addressed as a message from the node 2 to the message recipient B. As a result, not only will it be difficult for a third party to successfully intercept both of the partial messages because they are communicated along entirely different routes through different ISP's but it will also be difficult for the third party to identify the first and second partial messages M and N as being related to one another.

The combined arrangement of FIG. 11 will also avoid problems in the unusual situation that two of the four ISP's are physically close together so that the separate communications routes in fact pass through the same physical communications links.

In order to obtain the best level of security network diversity can be used. That is, the first and second partial messages can be sent through separate communications networks.

A sixth embodiment of the invention employing network diversity is shown in FIG. 12.

In the sixth embodiment the message originator A and the message recipient B are able to communicate through two separate networks, network 1 and network 3. In this case network 1 is the Internet 1 and network 3 is another network such as a satellite communications network 3.

The message originator A divides the message into two streams of fragments which are incorporated into first and second partial messages M and N in the same way as in the previous embodiments. The first partial message M is sent to an Internet IP address X at the message recipient B while the second partial message N is sent to a satellite network address Q at the message recipient B.

The message originator A sends the first partial message to the first ISP A. The first ISP A passes the message through the Internet 1 to the second ISP B. Finally, the second ISP B sends the first partial message to the IP address X of the message recipient B.

The message originator A sends the second partial message N to a first satellite network service provider NSP E. The first satellite NSP E sends the second partial message through the satellite network 3 to a second satellite NSP F. The second NSP F then sends the second partial message N to a network address Q of the message recipient B.

By the use of network diversity in the sixth embodiment the difficulty encountered by an unauthorised third party in intercepting both partial messages is further increased because the two partial message travel along different routes through different physical communications links forming parts of different networks.

In practice very few third parties will have the resources or capability to intercept messages travelling along two separate communications networks. Even if a third party is able to intercept messages travelling through two separate networks, network 1 and network 3 in the example, in principle, it will be extremely difficult for a third party to identify the two partial messages travelling through the first and second separate networks as both being from the message originator A to the message recipient B and being partial messages relating to the same original message.

The network diversity of the sixth embodiment can be combined with the use of proxy nodes according to the fourth embodiment.

An example of such a combination is shown in FIG. 13 which is based on the fifth embodiment shown in FIG. 12. In the example of FIG. 13, a proxy node 4 is connected to the satellite network 3 for communication with the first NSP E and the second NSP F.

In the example of FIG. 13 the first partial message M is sent by the message originator A to the message recipient B through the first ISP A, the second ISP B and the Internet 1 as in the fifth embodiment. The second partial message N is sent by the message originator A to a network address P of the node 4. The message originator A sends the second partial message N to the first NSP E which sends it to the network address P of the node 4 through the satellite network 3. The node 4 receives the second partial message N at the network address P and then resends the second partial message N to the network address Q of the message recipient B. The node 4 forwards a second partial message N to the second NSP F through the satellite network 3 and the second NSP F sends the second partial message N to the network address Q of the message recipient.

The message recipient B then recombines the message fragments in the first and second partial messages M and N to reproduce the original message.

The use of a node 4 increases the degree of security provided to a higher level than is provided by network diversity alone by making it more difficult for a third party to successfully intercept the partial messages and making it more difficult for a third party to correlate intercepted partial messages as being partial messages derived from the same original message.

In the examples above of the fifth and sixth embodiments of the invention employing multiple connection and network diversity respectively the message originator A and message recipient B are each connected to a network or networks by two service providers. If this is not possible and only one of the message originator A and message recipient B is connected to two service providers the invention is still applicable and can provide improved security, although not to as great a degree as when both the message originator A and the message recipient B are connected to two service providers.

An example of the invention showing such a situation where the message originator A is connected to two separate service provider serving separate networks but the message recipient B is only connected to a single service providers is shown in FIG. 14.

The example of FIG. 14 is based on the example of the sixth embodiment shown in FIG. 12 and the example of FIG. 13. In the example of FIG. 14 the message recipient B is connected to a single service provider SPG connected to the Internet 1 and to the satellite network 3 for communication with the first ISP A and the node 4 respectively.

In the example of FIG. 14 the message originator A divides the message into two streams of fragments which are incorporated into first and second partial messages M and N in the same way as in the previous embodiments and examples. The first partial message M is sent to an IP address X at the message recipient B while the second partial message is sent to a satellite network address Q also at the message recipient B.

The message originator A sends the first partial message to the first ISP A. The first ISP A passes the message through the Internet 1 to the service provider SP G. Finally, SP G sends the first partial message to the IP address X of the message recipient B.

The message originator A sends the second partial message N to a network address P of the node 4. The message originator A sends the second partial message N to the first NSP E which sends it to the network address P of the node 4 through the satellite network 3. The node 4 receives the second partial message N at the network address P and then resends the second partial message N to the network address Q of the message recipient B. The node 4 forwards the second partial message N to the service provider SP G through the satellite network 3. Finally, the SP G sends the second partial message N to the network address Q of the message recipient.

Then, the message recipient recombines the message fragments contained in the two partial messages to reproduce the original message.

It will be appreciated that the example of FIG. 14 provides less security than the example of FIG. 13 which is a corresponding arrangement in which B is connected to separate network service providers rather than a single service provider connected to both networks because both partial messages are routed through a single service provider SP G. However, because the two partial messages travel through separate networks for some of their journey between the message originator A and the message recipient B and one of the partial messages is routed through a proxy node 4, the example of FIG. 8 will provide greater security than the use of stream and path diversity according to the first to third embodiments in which the message recipient B is also only connected to a single service provider.

It will be appreciated that the embodiments and examples described above are purely specific examples of the invention. The use of the Internet and IP addresses is described in the examples for simplicity because the Internet is expected to be the most commonly used network for the foreseeable future. However, it should be understood that the invention can be used in other types of network and that where this is done appropriate network addresses should be used in place of IP addresses. For example, instead of IP addresses ATM (asynchronous transfer mode) virtual circuits could be specified as addresses where appropriate. It should be appreciated that the network across which the partial messages are sent could be an internal network within a device. Further, the invention can be applied, where appropriate, to the physical layer or transport layer, rather than the network layer, as alternative applications, for example, by means of photon-switching between fibre optic cables, or between fibres within such a cable. Similarly, diverse communications could be established using different channels or transponders on a communications satellite, or different satellites. Where the Internet is used in the examples the use of Internet service providers (ISP's) is specified. If other networks are used appropriate network service providers would be employed.

In the illustrated examples the message originator and message recipient are shown as being distinct from the service providers. This will usually be the case but it would of course be possible for the message originator or message recipient to be a service provider. However, even where this is the case it will normally be possible to distinguish the functions of dividing an original message into fragments and partial messages and recombining the partial messages and fragments into the original message at the message originator and message recipient respectively from the service provider function.

In the described embodiments and examples the invention is discussed in terms of the original message being divided into two streams of fragments which are in turn incorporated into two partial messages. This is the simplest way of carrying out the invention but an original message could be divided into a larger number of fragment streams and sent as a corresponding number of partial messages. In practice it is expected that the number of fragment streams and corresponding number of partial messages will be in the range 2 to 16 is most applications.

The described embodiments can be combined to provide increased levels of security. In principle there is no limit to how complex the routing arrangements of the different partial messages between the message originator and a message recipient can be. Similarly to conventional encryption based security systems the limits in practical embodiments will be set by the increased cost of sending messages by very complex routes.

In general the described first to sixth embodiments provide increasing levels of security, but the methods of the earlier embodiments can be incorporated into the methods of the later embodiments. For instance, as shown in the example of FIG. 13 the route diversity by the use of nodes of the fourth embodiment can be used together with the network diversity of the sixth embodiment. Multiple connection diversity according to the fifth embodiment can also be provided within an or each network when network diversity according to the sixth embodiment is used. These combinations both require that the number of partial messages was greater than the number of networks.

Similarly, where path or network diversity according to the fourth to sixth embodiments is used, stream diversity according to the second embodiment or path diversity according to the third embodiment could be provided by dividing the original message into a greater number of partial messages than the number of connections or networks so that multiple partial messages are passed along each of the separate networks or connection paths.

Similarly, where nodes are used the possible methods are not limited to the use of a single node to receive and resend a single partial message. It would be possible for one, some or all of the partial messages to be sent by routes employing nodes. Further, it would be possible for one node to readdress a received partial message and send it on to a further node, this being repeated as many times as desired before the partial message is finally sent to the message recipient.

In the above description and embodiments and examples the secure communications method according to the invention is described in terms of the sending of messages from a message originator to a message recipient. It will be understood that the communications method is fully reversible so that messages can similarly and simultaneously be sent from the message recipient to the message originator, even in the non-symmetrical example of FIG. 8. Similarly, it will be understood that the method can be used by a message originator to send the same message to multiple message recipients.

When an original message is formed into a number of partial messages, the original message is broken into a series of message fragments. As explained above, the message fragments may be smaller than the base unit used for communication in the networks employed and will typically be in the range 2 to 7 bits. In theory the individual fragments could be sent as separate partial messages. However, this will result in a very large number of partial messages so that it will normally be preferred to include a plurality of message fragments within each partial message. The simplest method of arranging this is to separate the original message into fragments and then assign the fragments in turn to the plurality of partial messages, the assignment being carried out cyclically.

This method of assigning message fragments to partial messages will result in each of the partial messages contained approximately the same number of message fragments so that the partial messages will be of approximately equal size. This is not essential and the message fragments could be assigned to the partial messages to result in different partial messages containing different numbers of message fragments.

One possible use of the invention which the message fragments would be differentially assigned could be in sending video signals where only an occasional message fragment is extracted from the video data stream and the video signal is sent with most of the video data being in a first partial message with only the very much smaller amount of data carried by the separated fragments being sent as a second partial message. Although in this case the partial message containing the bulk of the video data would contain nearly all of the video data it will still not be possible to view and display the video without combining the two partial messages because the locations at which the missing fragments should be inserted would not be known.

As explained above, the simplest method of carrying out the invention is to divide the message fragments evenly between a plurality of partial messages so that the partial messages are all essentially the same size. However, when network diversity according to the sixth embodiment is used the cost of using different ones of the networks may be significantly different. For example, in the described embodiments and examples, it would normally be expected that the cost of sending data through a satellite communications network would be greater than the cost of sending data through the Internet. When this is the case, in order to minimise the cost of sending messages using the inventive method it may be convenient to assign more message fragments to the message to be sent through the cheaper network than to the partial message to be sent through the more expensive network. An alternative or complimentary approach would be to assign the message fragments from the original message to more than two partial messages and send only one of the partial messages through a more expensive network with all of the others being sent through the cheaper network.

In order to ensure that individual partial messages cannot allow the original message to be inferred or deduced, where the original message is very short, for example yes or no, it is preferred that the original message is bulked out with meaningless padding information to ensure that the fragmentation process effectively obscures the original message.

The embodiments and examples described relate to the use of separate networks in parallel in order to provide security enhancing network diversity. It would of course be possible for individual partial messages to travel through two or more separate networks in series. However, such transmission of partial messages through multiple networks in series will not provide the advantage of network diversity in its own right. However, it is expected that employing message routes for the partial messages passing through two or more networks in series will provide some security advantage by making it more difficult for a third party intercepting the partial messages to identify them as part of the messages travelling from the message originator to the message recipient. This is expected to be particularly advantageous in enhancing security if a node is used able to receive messages through one network and to retransmit them through another network.

Where a node is used, the possibility of sending two partial messages to the node from the message originator and the node recombining the two partial messages to provide a further partial message to be forwarded to the message recipient identifying the message recipient is discussed above with reference to the third embodiment of the invention only. It will be understood that such a technique of fragmenting partial messages to form second or higher generation partial messages and recombining the second or higher generation partial messages at intermediate nodes to reproduce the partial messages to be sent to the message recipient so that the address or identity of the message recipient cannot be deduced from the second or higher generation partial messages is equally applicable to the methods of the fourth and fifth embodiments and the examples.

A further possibility where a node is used is that a single parent message could be sent by the message originator to a node and the node could fragment the received message into a number of daughter partial messages to be sent further.

It should be understood that both of the techniques explained above of using nodes to recombine received partial messages or to fragment received messages into partial messages can be repeated through as many stages as required. That is, in either case the message or partial messages received by the node may be partial messages fragmented by the message originator or an earlier node. Further, the message or partial messages produced by a node may be treated as partial messages and be recombined by the message receiver or a later node.

It should be noted that the partial messages and the fragment streams incorporated into the partial messages are asynchronous. This is necessary in order to allow for the differences in transmission times through different networks or along different routes through the same network. Further, this asynchronicity provides the advantage that a third party eavesdropper cannot deduce that two partial messages simultaneously received at two addresses associated with the message recipient must be derived from the same original message. In view of this asynchronicity, it should be understood that references to the order in which the partial messages travel along separate routes or pass between the message originator and the message recipient should only be taken as indicating a defined temporal relationship where they refer to the same partial message and should not be taken as implying any defined temporal relationship between events relating to different partial messages. That is, in the described embodiments and examples each partial message must travel through the various stages of its journey in order but there is no defined temporal relationship between the times at which different stages are carried out by different ones of the partial messages.

The invention is applicable to any digital communications network, including electronic and optical networks. Some of the examples described above relate to the use of the invention on the Internet using IP addresses. The invention is equally applicable for use with ATM where virtual circuits are used analogously to the IP addresses in the examples.

The embodiments and examples described herein as described by way of example only and the person skilled in the art will be able to see ways in which these could be combined and extended all remaining with the scope of the invention as defined by the appended claims.

1. A secure communications method comprising the steps of:
fragmenting a digital message into a series of fragments, at least some of the fragments being smaller or larger than the smallest base unit of data used by the communications network;
carrying out a reversible operation on the fragment stream,
sending the fragment stream through at least one digital communication network; and
reversing the operation carried out on the fragment stream to reproduce the digital message.

2. A method according to claim 1 in which the length of the fragments is varied.

3. A method according to claim 1 or claim 2, in which the reversible operation includes changing the order of the fragments.

4. A method according to any preceding claim, in which the reversible operation includes encrypting the fragments.

5. A method according to any preceding claim, in which the reversible operation includes dividing the fragments into a plurality of fragment streams;
forming a plurality of partial messages, each incorporating a fragment stream; and
recombining the fragment streams from the partial message.

6. A method according to claim 5 in which the plurality of partial messages are sent from a message originator to a message receiver, the message receiver has at least two network addresses and at least one of the plurality of partial messages is sent to each of the network addresses.

7. A method according to claim 5 or claim 6, in which the plurality of partial messages are sent from a message originator to a message receiver, at least one of the message originator and the message receiver is connected to at least two network service providers and at least one of the plurality of partial messages is sent through each service provider.

8. A method according to claim 7, in which the message originator and message receiver are both connected to at least two respective service providers and at least one of the plurality of partial messages is sent through each service provider.

9. A method according to any one of claims 5 to 8, in which the plurality of partial messages are sent from a message originator to a message receiver, at least one of the message originator and the message receiver is connected to at least two digital communications networks and at least one of the plurality of partial messages is sent through each network.

10. A method according to claim 9, in which the message originator and the message receiver are both connected to at least two digital communications networks and at least one of the plurality of partial messages is sent through each network.

11. A method according to any one of claims 5 to 10, in which the plurality of partial messages are sent from a message originator to a message receiver and at least one of the plurality of partial messages is sent from the message originator to a node and then resent from the node to the message receiver.

12. A method according to any preceding claim in which the, or one digital communications network is the Internet.

13. A method according to claim 6 in which different numbers of partial messages are sent to different ones of the network addresses.

14. A method according to claim 7 or claim 8 in which different numbers of partial messages are sent through different ones of the service providers.

15. A method according to claim 9 or claim 10 in which different numbers of partial messages are sent through different ones of the networks.

16. A method according to any preceding claim in which the reversible operation includes encrypting the fragments using a stream cipher.

17. A method according to any one of claims 5 to 16 in which the reversible operation includes encrypting at least one fragment stream using a block cipher.

18. A method according to claim 4 when dependent on claim 3, in which the reversible operation includes;
changing the order of the fragments;
encrypting the fragments using a block cipher;
dividing the fragments into a plurality of partial messages; and
recombining the partial messages.

19. Apparatus arranged to carry out the secure communications method of any preceding claim.
